(19) United States
(12) Patent Application Publication
(10) Pub. No.: US 2023/0037976 A1
(43) Pub. Date: Feb. 9, 2023

(54) POWER SUPPLY AND DISTRIBUTION SYSTEM

(71) Applicant: HUAWEI TECHNOLOGIES CO., LTD., Shenzhen (CN)

(72) Inventors: Peng SHUAI, Shenzhen (CN); Shaohua WANG, Shenzhen (CN)

(21) Appl. No.: 17/972,265

(22) Filed: Oct. 24, 2022

Related U.S. Application Data
(63) Continuation of application No. PCT/CN2020/086967, filed on Apr. 26, 2020.

(51) Int. Cl. H02J 7/02; H02J 7/00; B60L 53/62

(52) U.S. Cl. CPC H02J 7/02; H02J 7/0042; H02J 7/0029; B60L 53/62; H02J 2207/20; B60L 2210/10; B60L 2210/30

(57) ABSTRACT

Provided is a power supply and distribution system, the power supply and distribution system includes at least one non-isolated AC/DC converter unit, an MV DC bus and multiple isolated DC/DC converter units, and the at least one non-isolated AC/DC converter unit is connected between an MV AC grid and the MV DC bus, and is configured to convert an input MV AC voltage to an output MV DC voltage, where the output MV DC voltage is fed into the MV DC bus, the multiple isolated DC/DC converter units are connected to the MV DC bus in parallel via MV class cables, and are configured to convert a voltage level from the MV DC bus to a charging voltage level. The power supply and distribution system can be used for charging the EVs.

### CROSS-REFERENCE TO RELATED APPLICATION

This application is a continuation of International Application No. PCT/CN2020/086967, filed on Apr. 26, 2020, the disclosure of which is hereby incorporated by reference in its entirety.

### TECHNICAL FIELD

The present disclosure relates to the technical field of power conversion technology, and in particular, to a power supply and distribution system.

### BACKGROUND

The technical solution of the conventional direct current (DC) charging station for electric vehicles (EVs) is based on power supply from medium voltage (MV) grid. The alternative current (AC) voltage from MV level is adjusted to a low voltage (LV) level, e.g. 380V, by power transformers operated at grid frequency (for example, 50/60 Hz), and further supplied to the charging station for EV. An isolated AC/DC power converter is required to convert the AC voltage to a DC voltage adjustable in a given range for charging the battery of EVs. This AC/DC converter also provides galvanic isolation between any two outputs of the charging terminals.

FIG. 1 is a schematic diagram of a conventional power supply and distribution system with integrated chargers for EVs. As shown in FIG. 1, the AC/DC converter is arranged in a single cabinet together with the corresponding charging monitoring and control terminal. The power is distributed to each charger located on different parking slots via LV AC cables.

FIG. 2 is a schematic diagram of another conventional power supply and distribution system with separated chargers for EVs. As shown in FIG. 2, the AC/DC converter is arranged separated to the charging monitoring and control terminal. Similar as the power supply and distribution system as shown in FIG. 1, the LV power provided by the power transformer is collected from the LV AC bus and further distributed to each charger. The system in FIG. 2 differs from the system in FIG. 1 in that the charging monitoring and control terminal is located on each parking slot, and the power from the AC/DC converter is transferred to the charging terminals via LV DC cables as shown in FIG. 2.

However, in both systems in FIG. 1 and FIG. 2, the power transformers operated at the grid frequency are required to provide voltage level adaption from MV to LV and galvanic isolation. This kind of power transformers are bulky and heavy and occupy significant space which leads to high cost. For both systems in FIG. 1 and FIG. 2, there are two stages of galvanic isolation (power transformer and isolated AC/DC converter), which results in high power losses and low power conversion efficiency of the system. Further, the buses in both systems in FIG. 1 and FIG. 2 are LV AC bus, which is not convenient for connecting DC-type energy storage devices and renewable energy generation systems, e.g. photovoltaic power and battery storage system, and the power cannot be flexibly shared among different chargers. Furthermore, considering practical scenarios of charging station with many parking lots, in the system in FIG. 1, long LV AC cables are needed to distribute the power to each charger, and in the system in FIG. 2, long LV DC cables are needed, therefore, in both systems in FIG. 1 and FIG. 2, the power is distributed under low voltage, the current is thus relatively high, cables with relatively large diameters and therefore more copper material are necessary, which leads to high cost.

This background information is provided to reveal information believed by the applicant to be of possible relevance to the present disclosure. No admission is necessarily intended, nor should be construed, that any of the preceding information constitutes prior art against the present disclosure.

### SUMMARY

In view of the above, in order to overcome the above problem, the present disclosure provides a power supply and distribution system.

The foregoing and other objects are achieved by the subject matter of the independent claims. Further implementation forms are apparent from the dependent claims, the description and the figures.

According to a first aspect the present disclosure relates to a power supply and distribution system, the power supply and distribution system includes at least one non-isolated AC/DC converter unit, an MV DC bus and multiple isolated DC/DC converter units, and the at least one non-isolated AC/DC converter unit is connected between an MV AC grid and the MV DC bus, and is configured to convert an input MV AC voltage to an output MV DC voltage, where the output MV DC voltage is fed into the MV DC bus, the multiple isolated DC/DC converter units are connected to the MV DC bus in parallel via MV class cables, and are configured to convert a voltage level from the MV DC bus to a charging voltage level.

With the power supply and distribution system provided in the present disclosure, there is only one stage galvanic isolation between the MV AC grid and a charging output, the power loss can be significantly reduced compared to the systems with two stage galvanic isolations. Thereby, the power conversion efficiency is improved. Further, the charging power is distributed through the MV class cables, the electric current transmitted via the MV class cables is much smaller than that of LV class cables. Thereby, the required cross-sectional area of the cables used for distributing the MV AC voltage is much smaller than that of the LV class cables, which results in significant cost reduction of the cables for distributing power.

In a first possible implementation form of the system according to the first aspect as such, the output MV DC voltage is at least 1500V.

In the example conventional power supply and distribution systems shown in FIG. 1 and FIG. 2, the input MV AC voltage is adjusted to a LV voltage, e.g. 380V. In embodiments of the present application, the output MV DC voltage of the at least one non-isolated AC/DC converter unit is at least 1500V. Thus the electric current transmitted via cables used for distributing the LV voltage is much smaller than that of cables used for distributing the MV AC voltage, then the required cross-sectional area of the cables used for distributing the MV AC voltage is much smaller than that of the LV class cables, which results in significant cost reduction of the cables for distributing power.

In a second possible implementation form of the system according to the first aspect as such or the first possible implementation form of the system, each of the at least one non-isolated AC/DC converter unit is a multilevel AC/DC converter, and the multilevel AC/DC converter includes multiple AC/DC converter cells which are connected in series at an input side of the multilevel AC/DC converter.

In this case, each of the multiple AC/DC converter cells is based on an LV class switching semiconductor device.

In a third possible implementation form of the system according to the first aspect as such or the first possible implementation form of the system, each of the at least one non-isolated AC/DC converter unit includes one AC/DC converter cell.

In this case, the AC/DC converter cell is based on an MV class switching semiconductor device.

In a fourth possible implementation form of the system according to the first aspect as such or the first possible implementation form of the system, each of the at least one non-isolated AC/DC converter unit includes multiple AC/DC converter cells which are connected in parallel at both an input side and an output side of the multiple AC/DC converter cells.

In this case, each of the multiple AC/DC converter cells is based on an MV class switching semiconductor device.

In a fifth possible implementation form of the system according to the first aspect as such or any one of the first to fourth possible implementation form of the system, each of the multiple isolated DC/DC converter units includes multiple isolated DC/DC converter cells which are connected in series at an input side of the multiple isolated DC/DC converter cells and in parallel at an output side of the multiple isolated DC/DC converter cells.

In this case, each of the multiple isolated DC/DC converter cells is based on an LV class switching semiconductor device.

In a sixth possible implementation form of the system according to the first aspect as such or any one of the first to fourth possible implementation form of the system, each of the multiple isolated DC/DC converter units includes multiple isolated DC/DC converter cells which are connected in parallel at both an input side and an output side of the multiple isolated DC/DC converter cells.

In this case, each of the multiple isolated DC/DC converter cells is based on an MV class switching semiconductor device.

In a seventh possible implementation form of the system according to the fifth possible implementation form or the sixth possible implementation form of the system, each of the multiple isolated DC/DC converter cells includes at least one medium frequency transformer (MFT).

The MFT in each of the multiple isolated DC/DC converter units provides one stage of galvanic isolation.

In an eighth possible implementation form of the system according to the first aspect as such or any one of the first to fourth possible implementation form of the system, each of the multiple isolated DC/DC converter units includes one isolated DC/DC converter cell.

In this case, each of the multiple isolated DC/DC converter cells is based on an MV class switching semiconductor device.

In a ninth possible implementation form of the system according to eighth possible implementation form of the system, the isolated DC/DC converter cell includes at least one MFT.

The MFT in the isolated DC/DC converter cell provides one stage of galvanic isolation.

In a tenth possible implementation form of the system according to the seventh possible implementation form or the ninth possible implementation form of the system, an operating frequency of the MFT is higher than a frequency of the MV AC grid.

In a eleventh possible implementation form of the system according to the first aspect as such or any one of the first to tenth possible implementation form of the system, the power supply and distribution system further includes multiple charging terminals correspond to the multiple isolated DC/DC converter units, where each of the multiple isolated DC/DC converter units and a corresponding charging terminal are included in a charger, where the charging terminal is configured to receive charging requirement of an electric vehicle, and control a corresponding isolated DC/DC converter unit to output a charging current for the electric vehicle.

In a twelfth possible implementation form of the system according to the first aspect as such or any one of the first to eleventh possible implementation form of the system, the power supply and distribution system further includes multiple DC distributing units connected in the MV DC bus and the MV class cables, respectively, and each of the multiple DC distributing units includes a switch and a protection device, and is configured to detect and isolate a fault in the MV DC bus and the MV class cables.

With the multiple DC distributing units connected in the MV DC bus and the MV class cables in the system, a fault can be detected and isolated, then other healthy devices and equipment can be protected.

In a thirteenth possible implementation form of the system according to the first aspect as such or any one of the first to twelfth possible implementation form of the system, the power supply and distribution system further includes an MV switch gear connected between the MV AC grid and the at least one non-isolated AC/DC converter unit.

With the MV switch gear connected between the MV AC grid and the at least one non-isolated AC/DC converter unit in the system, the connection between the MV AC grid and the at least one non-isolated AC/DC converter unit can be connected and disconnected from the MV grid.

In a fourteenth possible implementation form of the system according to the first aspect as such or any one of the first to thirteenth possible implementation form of the system, the power supply and distribution system further includes at least one DC type power generator connected to the MV DC bus via at least one first DC/DC converter that corresponding to the at least one DC type power generator.

In a fifteenth possible implementation form of the system according to the first aspect as such or any one of the first to fourteenth possible implementation form of the system, the power supply and distribution system further includes at least one DC type energy storage unit connected to the MV DC bus via at least one second DC/DC converter that corresponding to the at least one DC type energy storage unit.

With the at least one DC type power generator connected to the MV DC bus via the at least one first DC/DC converter and the at least one DC type energy storage unit connected to the MV DC bus via the at least one second DC/DC converter, the power can be generated and stored for using when a failure of the MV AC grid occurs.

In a sixteenth possible implementation form of the system according to the first aspect as such or any one of the first to fifteenth possible implementation form of the system, the at least one non-isolated AC/DC converter unit is configured as unidirectional or bidirectional for power transfer.

The power can only be transmitted from the MV AC grid side to the charger side when the at least one non-isolated AC/DC converter unit is configured as unidirectional for power transfer, and the charging power is provided by the MV AC grid side. The power generated by the DC type power generator and stored by the DC type energy storage unit can also be feedback to the MV AC grid side when the at least one non-isolated AC/DC converter unit is configured as bidirectional for power transfer.

### BRIEF DESCRIPTION OF DRAWINGS

The accompanying drawings are used to provide a further understanding of the present disclosure, constitute a part of the specification, and are used to explain the present disclosure together with the following specific embodiments, but should not be construed as limiting the present disclosure. In the drawings,

FIG. 1 is a schematic diagram of a conventional power supply and distribution system with integrated chargers for EVs;

FIG. 2 is a schematic diagram of another conventional power supply and distribution system with separated chargers for EVs;

FIG. 3 is a schematic diagram of a power supply and distribution system according to an embodiment of the present application;

FIG. 4 is a schematic diagram of a non-isolated AC/DC converter unit according to an embodiment of the present application;

FIG. 5 is a schematic diagram of another non-isolated AC/DC converter unit according to an embodiment of the present application;

FIG. 6 is a schematic diagram of an isolated DC/DC converter unit according to an embodiment of the present application;

FIG. 7 is a schematic diagram of another isolated DC/DC converter unit according to an embodiment of the present application;

FIG. 8 is a schematic diagram of another power supply and distribution system according to an embodiment of the present application; and

FIG. 9 is a schematic diagram of yet another power supply and distribution system according to an embodiment of the present application.

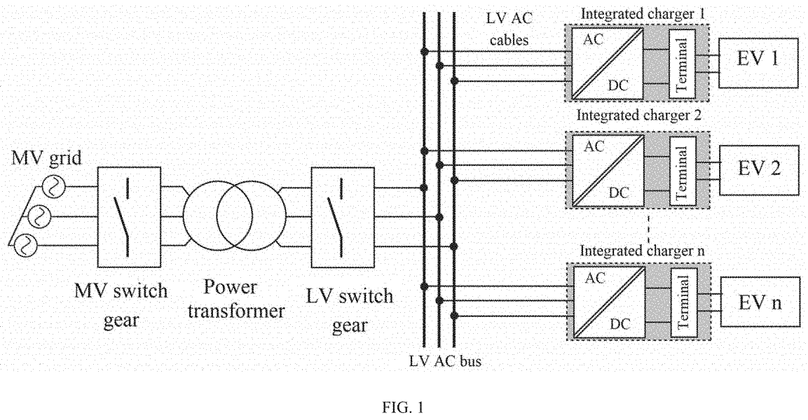

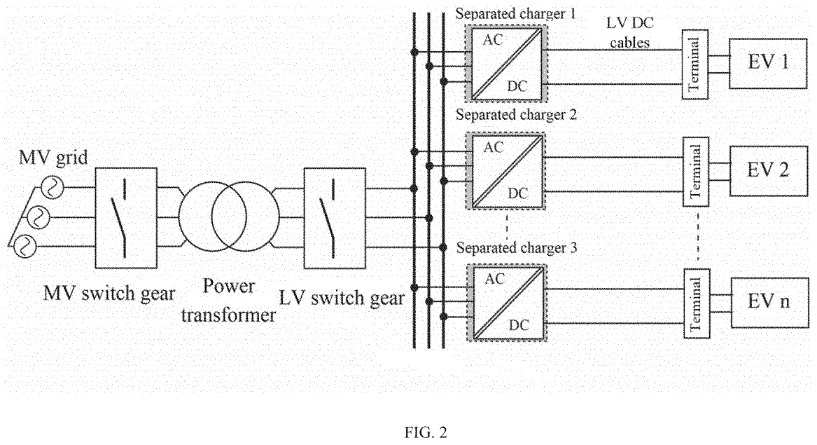

### DESCRIPTION OF EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

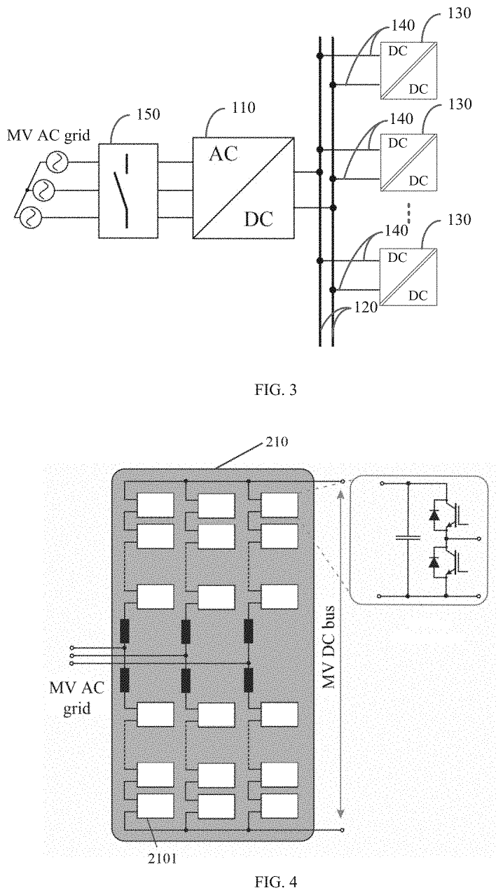

FIG. 3 is a schematic diagram of a power supply and distribution system according to an embodiment of the present application, as shown in FIG. 3, the power supply and distribution system includes one non-isolated AC/DC converter unit 110, an MV DC bus 120 and multiple isolated DC/DC converter units 130, and the non-isolated AC/DC converter unit 110 is connected between an MV AC grid and the MV DC bus 120, and is configured to convert an input MV AC voltage to an output MV DC voltage, where the output MV DC voltage is fed into the MV DC bus 120, the multiple isolated DC/DC converter units 130 are connected to the MV DC bus 120 in parallel via MV class cables 140, and are configured to convert a voltage level from the MV DC bus 120 to a charging voltage level.

Further, the power supply and distribution system further includes an MV switch gear 150 connected between the MV AC grid and the non-isolated AC/DC converter unit 110.

With the power supply and distribution system provided in this embodiment, due to that the AC/DC converter unit in the power supply and distribution system is the non-isolated AC/DC converter unit 110, the DC/DC converter unit in the power supply and distribution system is the isolated DC/DC converter unit 130, there is only one stage galvanic isolation between the MV AC grid and a charging output, the power loss can be significantly reduced compared to the systems with two stage galvanic isolations. Thereby, the power conversion efficiency is improved. Further, the charging power is distributed through the MV class cables 140, the electric current transmitted via the MV class cables 140 is much smaller than that of LV class cables. Thereby, the required cross-sectional area of the cables used for distributing the MV AC voltage is much smaller than that of the LV class cables, which results in significant cost reduction of the cables for distributing power.

According to the DC power standard, the voltage below 1500V is referred as low voltage, and the voltage above 1500V is referred as medium voltage. Thus, the output MV DC voltage the non-isolated AC/DC converter unit 110 is at least 1500V. In an implementation, the output MV DC voltage is higher than a voltage peak of the input MV AC voltage.

It should be understood that FIG. 3 is an example embodiment, the number of the non-isolated AC/DC converter unit is determined according to the power capacity of the power supply and distribution system. Due to that the power capacity of a single non-isolated AC/DC converter unit is limited, in other embodiments, there may be multiple non-isolated AC/DC converter unit when a charging station with a larger capacity of the system is needed or a capacity expansion of the system is performed.

With the MV switch gear 150 connected between the MV AC grid and the at least one non-isolated AC/DC converter unit 110 in the system, the connection between the MV AC grid and the at least one non-isolated AC/DC converter unit 110 can be connected and disconnected from the MV grid.

FIG. 4 is a schematic diagram of a non-isolated AC/DC converter unit according to an embodiment of the present application. As shown in FIG. 4, each of the at least one non-isolated AC/DC converter unit is a multilevel AC/DC converter 210, the multilevel AC/DC converter 210 includes multiple AC/DC converter cells 2101 which are connected in series at an input side of the multilevel AC/DC converter 210. In this embodiment, as shown in FIG. 4, each of the multiple AC/DC converter cells is based on an LV class switching semiconductor device. For example, each of the at least one non-isolated AC/DC converter unit is modular multilevel converter (MMC) based on LV class Si IGBT devices.

In an embodiment, each of the at least one non-isolated AC/DC converter unit includes one AC/DC converter cell. In this embodiment, the AC/DC converter cell is based on an MV class switching semiconductor device.

FIG. 5 is a schematic diagram of another non-isolated AC/DC converter unit according to an embodiment of the present application. As shown in FIG. 5, each of the at least one non-isolated AC/DC converter unit 310 includes multiple AC/DC converter cells 3101 which are connected in parallel at both an input side and an output side of the multiple AC/DC converter cells 3101. In this embodiment, as shown in FIG. 5, each of the multiple AC/DC converter cells 3101 is based on an MV class switching semiconductor device. For example, each of the at least one non-isolated AC/DC converter unit includes a 2-level or a 3-level AC/DC rectifier employing MV class silicon carbide (SiC). The non-isolated AC/DC converter unit 310 in FIG. 5 includes a 3-level AC/DC rectifier employing MV class SiC.

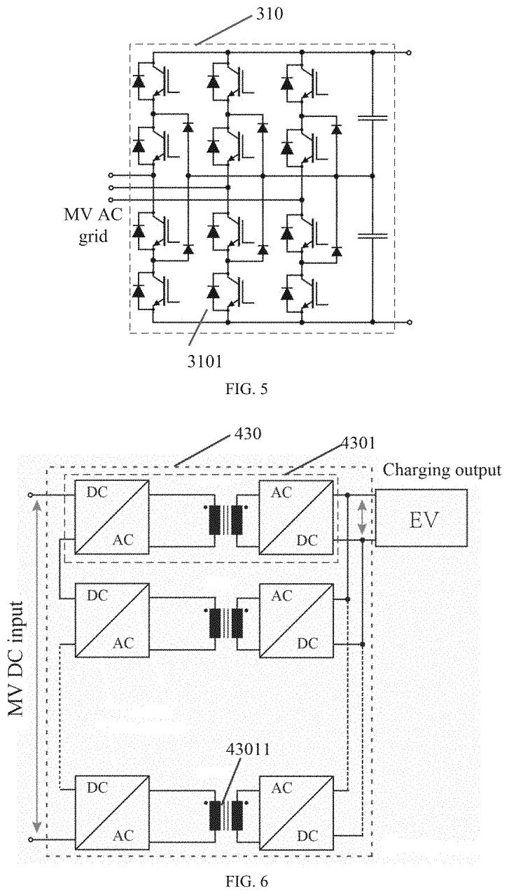

FIG. 6 is a schematic diagram of an isolated DC/DC converter unit according to an embodiment of the present application. As shown in FIG. 6, each of the multiple isolated DC/DC converter units 430 includes multiple isolated DC/DC converter cells 4301 which are connected in series at an input side of the multiple isolated DC/DC converter cells 4301 and in parallel at an output side of the multiple isolated DC/DC converter cells 4301. Further, each of the multiple isolated DC/DC converter cells 4301 includes at least one MFT 43011. In this embodiment, as shown in FIG. 6, each of the multiple isolated DC/DC converter cells 4301 is based on an LV class switching semiconductor device. For example, each of the at least one isolated AC/DC converter unit is based on LV class Si IGBT devices. The MFT 43011 in each of the multiple isolated DC/DC converter cells 4301 provides one stage of galvanic isolation.

In an embodiment, an operating frequency of the MFT 43011 is higher than a frequency of the MV AC grid.

In an embodiment, each of the multiple isolated DC/DC converter units includes multiple isolated DC/DC converter cells which are connected in parallel at both an input side and an output side of the multiple isolated DC/DC converter cells.

In this case, each of the multiple isolated DC/DC converter cells is based on an MV class switching semiconductor device.

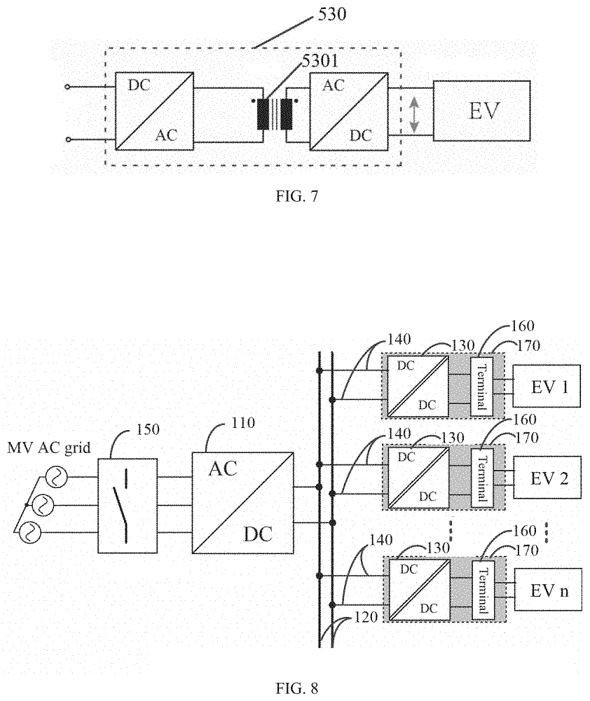

FIG. 7 is a schematic diagram of another isolated DC/DC converter unit according to an embodiment of the present application. As shown in FIG. 7, each of the multiple isolated DC/DC converter units includes one isolated DC/DC converter cell 530. In this embodiment, as shown in FIG. 7, the isolated DC/DC converter cell 530 is based on an MV class switching semiconductor device. For example, isolated DC/DC converter cell 530 is based on MV class SiC devices (only on MV DC side) to simplify the converter system. Further, the isolated DC/DC converter cell 530 includes at least one MFT 5301. The MFT 5301 in the isolated DC/DC converter cell 530 provides one stage of galvanic isolation.

In an embodiment, an operating frequency of the MFT 5301 is higher than a frequency of the MV AC grid.

FIG. 8 is a schematic diagram of another power supply and distribution system according to an embodiment of the present application. Based on the power supply and distribution system in FIG. 3, as shown in FIG. 8, the power supply and distribution system further includes multiple charging terminals 160 correspond to the multiple isolated DC/DC converter units 130, where each of the multiple isolated DC/DC converter units 130 and a corresponding charging terminal 160 are included in a charger 170, where the charging terminal 160 is configured to receive charging requirement of an EV, and control a corresponding isolated DC/DC converter unit 130 to output a charging current for the EV. Each of the multiple isolated DC/DC converter units 130 located in each corresponding charger 170 is dedicated to adjust the voltage from MV level to LV level required by the battery of an EV and provides the required galvanic isolation between the MV AC grid and the charging output as well as between any two charging outputs.

All of the multiple charging terminals 160 all draw electricity from the MV DC bus 120. Power distribution can be realized by adjusting the output power of the DC/DC converter via its corresponding charging terminal. Compared with the switching matrix power distribution unit, power distribution is simpler, and it is easy to maintain and expand capacity. Stepless power distribution can be realized through real-time scheduling among the multiple charging terminals 160.

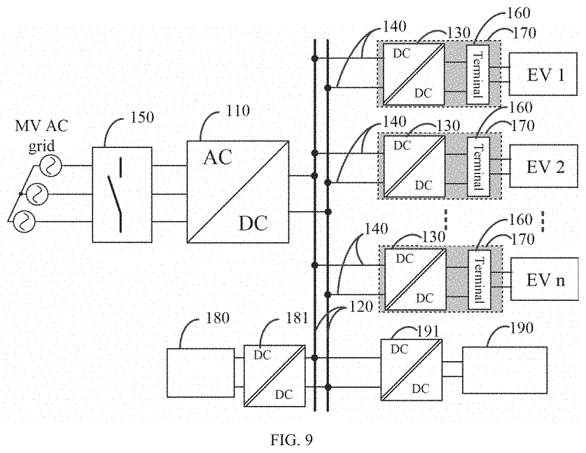

FIG. 9 is a schematic diagram of yet another power supply and distribution system according to an embodiment of the present application. Based on the power supply and distribution system in FIG. 8, as shown in FIG. 9, the power supply and distribution system further includes one DC type power generator 180 connected to the MV DC bus via one first DC/DC converter 181 corresponding to the DC type power generator 180 and one DC type energy storage unit 190 connected to the MV DC bus via one second DC/DC converter 191 corresponding to the DC type energy storage unit 190.

It should be understood that FIG. 9 is an example system which comprises one DC type power generator 180 connected to the MV DC bus via one first DC/DC converter 181 and one DC type energy storage unit 190 connected to the MV DC bus via one second DC/DC converter 191. In another embodiment, according to the capacity requirement of the power supply and distribution system, the number of the DC type power generator 180, the number of the first DC/DC converter 181, the number of DC type energy storage unit 190 or the number of the second DC/DC converter 191 may be multiple.

With the DC type power generator 180 connected to the MV DC bus via a first DC/DC converter and the DC type energy storage unit 190 connected to the MV DC bus via a second DC/DC converter, the power can be generated and stored for using when a failure of the MV AC grid occurs.

In an embodiment, the at least one non-isolated AC/DC converter unit is configured as unidirectional or bidirectional for power transfer.

The power can only be transmitted from the MV AC grid side to the charger side when the at least one non-isolated AC/DC converter unit is configured as unidirectional for power transfer, and the charging power is provided by the MV AC grid side. The power generated by the DC type power generator and stored by the DC type energy storage unit can also be feedback to the MV AC grid side when the at least one non-isolated AC/DC converter unit is configured as bidirectional for power transfer.

In an embodiment, the power supply and distribution system further includes multiple DC distributing units connected in the MV DC bus and the MV class cables, respectively, and each of the multiple DC distributing units includes a switch and a protection device, and is configured to detect and isolate a fault in the MV DC bus and the MV class cables.

With the multiple DC distributing units connected in the MV DC bus and the MV class cables in the system, a fault can be detected and isolated, then other healthy devices and equipment can be protected.

Terms such as “first”, “second” and the like in the specification and claims of the present disclosure as well as in the above drawings are intended to distinguish different objects, but not intended to define a particular order.

The term “a” or “an” is not intended to specify one or a single element, instead, it may be used to represent a plurality of elements where appropriate.

In the embodiments of the present disclosure, expressions such as “exemplary” or “for example” are used to indicate illustration of an example or an instance. In the embodiments of the present disclosure, any embodiment or design scheme described as “exemplary” or “for example” should not be interpreted as preferred or advantageous over other embodiments or design schemes. In particular, the use of “exemplary” or “for example” is aimed at presenting related concepts in a specific manner.

1. A power supply and distribution system, comprising at least one non-isolated alternative current (AC)/direct current (DC) converter unit, a medium voltage (MV) DC bus and multiple isolated DC/DC converter units;
wherein
the at least one non-isolated AC/DC converter unit is connected between an MV AC grid and the MV DC bus and is configured to convert an input MV AC voltage to an output MV DC voltage, wherein the output MV DC voltage is fed into the MV DC bus; and
the multiple isolated DC/DC converter units are connected to the MV DC bus in parallel via MV class cables and are configured to convert a voltage level from the MV DC bus to a charging voltage level.

2. The power supply and distribution system according to claim 1, wherein the output MV DC voltage is at least 1500V.

3. The power supply and distribution system according to claim 1, wherein each of the at least one non-isolated AC/DC converter unit is a multilevel AC/DC converter, and wherein the multilevel AC/DC converter comprises multiple AC/DC converter cells connected in series at an input side of the multilevel AC/DC converter.

4. The power supply and distribution system according to claim 1, wherein each of the at least one non-isolated AC/DC converter unit comprises one AC/DC converter cell.

5. The power supply and distribution system according to claim 1, wherein each of the at least one non-isolated AC/DC converter unit comprises multiple AC/DC converter cells connected in parallel at both an input side and an output side of the multiple AC/DC converter cells.

6. The power supply and distribution system according to claim 1, wherein each of the multiple isolated DC/DC converter units comprises multiple isolated DC/DC converter cells connected in series at an input side of the multiple isolated DC/DC converter cells and in parallel at an output side of the multiple isolated DC/DC converter cells.

7. The power supply and distribution system according to claim 1, wherein each of the multiple isolated DC/DC converter units comprises multiple isolated DC/DC converter cells connected in parallel at both an input side and an output side of the multiple isolated DC/DC converter cells.

8. The power supply and distribution system according to claim 6, wherein each of the multiple isolated DC/DC converter cells comprises at least one medium frequency transformer (MFT).

9. The power supply and distribution system according to claim 1, wherein each of the multiple isolated DC/DC converter units comprises one isolated DC/DC converter cell.

10. The power supply and distribution system according to claim 9, wherein each of the isolated DC/DC converter cells comprises at least one medium frequency transformer (MFT).

11. The power supply and distribution system according to claim 8, wherein an operating frequency of the MFT is higher than a frequency of the MV AC grid.

12. The power supply and distribution system according to claim 1, further comprising:
multiple charging terminals correspond to the multiple isolated DC/DC converter units, wherein each of the multiple isolated DC/DC converter units and a corresponding charging terminal are comprised in a charger, and wherein each of the multiple charging terminals is configured to receive charging requirement of an electric vehicle and control a corresponding isolated DC/DC converter unit to output a charging current for the electric vehicle.

13. The power supply and distribution system according to claim 1, further comprising:
multiple DC distributing units connected in the MV DC bus and the MV class cables, respectively, wherein each of the multiple DC distributing units comprises a switch and a protection device and is configured to detect and isolate a fault in the MV DC bus or the MV class cables.

14. The power supply and distribution system according to claim 1, further comprising:
an MV switch gear connected between the MV AC grid and the at least one non-isolated AC/DC converter unit.

15. The power supply and distribution system according to claim 1, further comprising:
at least one DC type power generator connected to the MV DC bus via at least one DC/DC converter that corresponds to the at least one DC type power generator.

16. The power supply and distribution system according to claim 1, further comprising:
at least one DC type energy storage unit connected to the MV DC bus via at least one DC/DC converter that corresponds to the at least one DC type energy storage unit.

17. The power supply and distribution system according to claim 1, wherein the at least one non-isolated AC/DC converter unit is configured as unidirectional or bidirectional for power transfer.

18. The power supply and distribution system according to claim 2, wherein each of the at least one non-isolated AC/DC converter unit is a multilevel AC/DC converter, and wherein the multilevel AC/DC converter comprises multiple AC/DC converter cells connected in series at an input side of the multilevel AC/DC converter.

19. The power supply and distribution system according to claim 2, wherein each of the at least one non-isolated AC/DC converter unit comprises one AC/DC converter cell.

20. The power supply and distribution system according to claim 2, wherein each of the at least one non-isolated AC/DC converter unit comprises multiple AC/DC converter cells connected in parallel at both an input side and an output side of the multiple AC/DC converter cells.
